(19) United States
(12) Patent Application Publication
(10) Pub. No.: US 2012/0240800 A1
(43) Pub. Date: Sep. 27, 2012

(54) APPARATUS AND METHOD FOR RAPID CLEANING OF CENTRAL DRUM OF FLEXOGRAPHIC PRINTING MACHINES

(75) Inventors: RICCARDO FUMAGALLI, Oggiono (IT); Marco Corti, Lecco (IT)

(73) Assignee: ELETTRA S.r.l., PROVINCE OF LECCO (IT)

(21) Appl. No.: 13/418,963

(22) Filed: Mar. 13, 2012

Related U.S. Application Data
(60) Provisional application No. 61/592,280, filed on Jan. 30, 2012.

(30) Foreign Application Priority Data
Mar. 23, 2011 (IT) BO2011A000142

(51) Int. Cl. B41F 35/02

(52) U.S. Cl. 101/425

(57) ABSTRACT

Apparatus and method for the rapid cleaning of the central drum of flexographic printing machines includes a cleaning device with presser, cloth and fluid. The presser brings the cloth into contact with the rotating drum. The presser undergoes a suitable oscillating movement parallel to the axis of the rotating drum. At the ends of the cleaning device, the shoulders of the base of the flexographic machine are equipped with any suitable opposed openings of the correct width through which the cleaning device can oscillate. The cleaning device periodically can be inserted or withdrawn axially through at least one of the openings to allow replacement of the cloth without the need to cut the substrate.

### CROSS REFERENCE TO RELATED APPLICATION

The present application claims priority to Italian Application No. BO2011A000142, filed 23 Mar. 2011, and U.S. provisional patent application Ser. No. 61/592,280, filed Jan. 30, 2012, which is hereby incorporated herein in its entirety for all purposes by this reference.

### FIELD OF THE INVENTION

The invention concerns printing machines and particularly apparatus and methods for cleaning ink and dirt that accumulate on the outer peripheral edges of the cylindrical surfaces of rotating cylinders of such machines.

### BACKGROUND OF THE INVENTION

Printing machines, e.g., flexographic machines, have rotating drums and/or cylinders that have surfaces that potentially affect, either by indirect or direct contact, the flexible web of paper or other material to be printed, such web usually and hereinafter designated the “substrate”. Dirt, which is often of considerable thickness of so-called format lines, i.e., those lines of ink and dirt which form on the outsides and on opposite peripheral edge portions of the cylindrical surfaces of the cylinders, periodically must be removed. The so-called central cylinder or drum of flexographic printing machines is one such cylindrical surface from which format lines must be removed. Known apparatus and methods for cleaning such drum include those described in U.S. Pat. Nos. 5,251,348; 5,275,104 and 7,011,025, the disclosure of each of these U.S. patents being hereby incorporated herein in its entirety for all purposes by this reference.

Italian patent application no. BO 2010 A-56 of Feb. 2, 2010 is believed to disclose the state of the art closest to the invention. According to this patent application, the cleaning apparatus and method provides for the use of a cleaning unit with cloth, presser and fluid, of a width correlated with that of the drum to be cleaned and parallel to the outer circumferential surface of said drum. A portion of cloth corresponding to the active surface of the presser is suitably moistened with cleaning fluids. This portion of cloth is thrust by the presser into contact with the outer circumferential surface of the drum, which remains in rotation. The entire cleaning device is moving in the direction of its width and therefore parallel to the axis of rotation of the drum, with an alternating longitudinal movement of small or medium amplitude, for example of the maximum order of 5-10 cm, in order to spread and extend the dirt over the entire transverse extension of the drum, thereby infinitesimally reducing the thickness of the dirt of the format lines.

After this operation of spreading the dirt, the cloth is made to advance through one or more short stretches and the presser remains in a static position and is thrust against the drum (which remains in rotation), until all the dirt is removed. This solution has the advantage of being able also to eliminate the format lines by the use over the whole width and therefore in a rational manner of the traditional system of cleaning with a wide cloth and a presser, normally used for cleaning the drum over the whole of its useful width. This system of cleaning, also because of the oscillation, of limited amplitude, of the cleaning system with wide cloth, has the limitation of requiring a considerable number of revolutions of the flexographic drum that is being cleaned, and therefore long execution times, with a considerable impact on the costs of being unable to use the printing machine during the cleaning time.

A further limitation of the known art lies in the fact that the cleaning cloth becomes soiled and periodically must be replaced with a clean roll of cloth. However, the cleaning device must be moved from a working position to a maintenance position each time it becomes necessary to replace the cloth that has become soiled. Such movement of the cleaning device from a working position to a maintenance position must occur in a direction that is normal to the axis of rotation of the drum. Thus, before such movement can begin, the continuous substrate to be printed must be cut in order to allow passage of the cleaning device to the maintenance position. Having to repeatedly cut and re-attach the substrate each time the soiled cloth must be replaced with clean cloth poses many drawbacks before the printing of the substrate can resume.

### BRIEF DESCRIPTION OF THE INVENTION

Aspects and advantages of the invention will be set forth in part in the following description, or may be obvious from the description, or may be learned through practice of the invention.

Apparatus for the rapid cleaning of the rotating surface of the central drum of flexographic printing machines desirably includes at least one cross-piece disposed parallel to the axis of the drum and slideably carried by and extending between the spaced apart shoulders of the flexographic printing machine. The cleaning apparatus desirably further includes a presser, a cleaning cloth, an oscillator and a dispenser of cleaning fluid. The presser, the cleaning cloth, and the dispenser of cleaning fluid desirably are carried by the cross-piece. The oscillator desirably is configured to impart to each of the presser and the cleaning cloth during a cleaning phase of operation, oscillating movement of alternating strokes directed parallel to the rotational axis of the drum. Moreover, the cleaning apparatus is configured to pass through an opening defined through at least one of the shoulders of the printing machine and to do so in a movement directed parallel to the axis of rotation of the drum to permit replacement of the cleaning cloth without having to cut the substrate. In one embodiment, the width of each of the presser and the segment of the cleaning cloth stretched over the presser is at least equal to the sum of the width of the drum and the alternating stroke which the presser performs in the cleaning phase so that the cleaning cloth always touches the drum over its entire transverse extension during the cleaning phase.

In one embodiment, the oscillator includes an actuator of alternating rectilinear motion which is constrained to one of said shoulders of the printing machine. The oscillator desirably further includes at least one primary slide located parallel to the axis of the drum to be cleaned and supported with its opposed ends and with the interposition of guide and slide means by the same shoulders which rotatably support the drum. The primary slide desirably is connected to the actuator of alternating rectilinear motion. The oscillator desirably further includes at least one secondary slide connected to the at least one cross-piece, the at least one secondary slide being configured for sliding drawer movement directed parallel to the axis of rotation of the drum. The oscillator still further desirably includes a latch that is carried by the secondary slide and that can be selectively locked to or unlocked from the at least one primary slide.

The presser desirably defines a plurality of holes distributed over the width of the presser, to feed from the dispenser of cleaning fluid to the cleaning cloth and through the cleaning cloth to the drum that is to be cleaned, exact quantities of cleaning fluid in the necessary quantity and never in excess. The dispenser of cleaning fluid desirably includes a spraying bar having a plurality of sections, each section including a plurality of spraying nozzles, and at least one valve desirably is connected to each section of the spraying bar. In some embodiments, a plurality of valves is connected to each section of the spraying bar.

The cleaning apparatus desirably further includes a controller connected to the valves of the spraying bar and programmed to control the valves to ensure that the feeding of cleaning fluid can occur in a way in which the cleaning fluid is distributed transversely onto the cleaning cloth with a quantitatively differentiated distribution of the cleaning fluid. The controller desirably is configured to control the distribution of the cleaning fluid so that the amount of cleaning fluid that is dispensed by the spraying bar decreases from the center of the presser towards the outside ends of the presser. The controller desirably is connected to the dispenser of cleaning fluid and configured to control the dispenser of cleaning fluid to dispense an exact quantity and distribution of cleaning fluid in relation to the length of the presser, the characteristics of the oscillatory movement of the presser and the speed of rotation of the drum so as to spread the dirt of a zone of the drum over the transverse extension of the drum in the form of a sufficiently thin film of sufficiently low solidity so that the thin film of dirt is removed from the zone of the drum within one revolution of the drum. In some embodiments, the controller is connected to the dispenser of cleaning fluid and configured to control the dispenser of cleaning fluid to dispense an exact quantity and distribution of cleaning fluid in relation to the length of the presser, the characteristics of the oscillatory movement of the presser and the speed of rotation of the drum so as to spread the dirt of each successive zone of the drum over the transverse extension of the drum in the form of a sufficiently thin film of sufficiently low solidity so that each successive dirty zone of the drum is dried and cleaned before exiting from the downstream end of the presser.

One embodiment of the presser desirably includes a beam, an actuator connecting the beam to the cross-piece, a plate with a lower face directed toward the drum and a sheet of elastomeric material connected to the lower face of the plate. In some embodiments, the plate has a rectangular shape, as wide as the beam, and has a curved lateral profile with a concave lower face directed towards the drum with a radius of curvature smaller than the radius of curvature of the drum and formed with characteristics of flexibility in the direction of its length, the opposite ends of the plate being slightly curved upwards away from the drum. In some embodiments, the plate is formed with characteristics of limited flexibility in the direction of its length that predispose the plate for supporting the elastomeric sheet only by the ends thereof and with a stretched arrangement, like a bowstring in such a way that when the presser is thrust against the drum, the elastomeric sheet intimately adapts to the surface of the drum, thrusting a large length of cleaning cloth into contact with the drum with distributed pressure. In some embodiments, the plate is substantially rigid and has a lower face directed towards the drum and defining a radius of curvature correlated with that of the drum, and the presser further includes a plurality of beam-shaped pressers fixed to the lower face of the upper plate, each beam-shaped presser being arranged parallel to each other beam-shaped presser and to the outer circumferential surface of said drum, each beam-shaped presser including a lower part of elastomeric material. Desirably, at least the lower part of the upstream presser includes a thrust surface of embossed type in order to exert an energetic action on the dirt. In some embodiments, at least the lower part of the downstream presser includes a thrust surface which is substantially smooth in order to be able to carry out an effective action of finishing the cycle of cleaning the drum.

The cleaning apparatus desirably further includes a rotatably supported feed reel for feeding unsoiled segments of the cleaning cloth and a rotatably supported collection reel for collecting soiled segments of the cleaning cloth, the feed reel and the collection reel being configured and disposed to carry the cleaning cloth under longitudinal tension beneath the presser. In some embodiments, a controller is connected to the feed reel and configured to control the feed reel to advance periodically enough unsoiled cleaning cloth so that only unsoiled cleaning cloth initially touches the drum when the presser is next placed in a static position thrust against the rotating drum.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic side view of a flexographic machine with the cleaning apparatus according to the invention;

FIG. 2 is a schematic partial view of the device for cleaning by cloth and presser, viewed in the direction indicated by the arrow K in FIG. 1 and with a first way of operating the said cleaning device;

FIG. 3 is a schematic partial view of the device for cleaning by cloth and presser, viewed in the direction indicated by the arrow K in FIG. 1 and with a second way of operating the said cleaning device;

FIG. 4 illustrates, extended on plan, a small zone of the outer surface of the printing drum, with the dirt of the format lines, in the evolution of the conditions from when said zone enters and from when it exits from the presser-and-cloth cleaning device concerned;

FIG. 5 illustrates, transversely sectioned and in the raised rest position, a device with presser and cloth according to an embodiment of the invention, with a presser of monolithic type;

FIG. 6 illustrates, transversely sectioned and in the low working position, a device with presser and cloth according to an embodiment of the invention, with a presser of monolithic type;

FIG. 7 illustrates, transversely sectioned and in the high rest position, a constructional variant of the device with monolithic presser as in the previous illustrations;

FIG. 8 illustrates, transversely sectioned and in the low working position, a presser-and-cloth cleaning device according to a constructional variant, with a presser of composite type;

FIG. 9 is a view on plan from above and with parts in section of an embodiment of the cleaning apparatus in the version with long oscillating stroke of the cleaning device with presser, cloth and fluid;

FIG. 10 illustrates further constructional details of the embodiment shown in FIG. 9, observed according to the transverse section lines X-X;

FIG. 11 illustrates further constructional details of the solution shown in FIG. 9, observed according to the transverse section lines XI-XI;

FIG. 12 schematically illustrates the details of an embodiment of a feed manifold and cleaning fluid transport apparatus;

FIGS. 13 and 14 show in schematic form a plan view of the further constructional variants for operation of the spraying bars of the apparatus according to embodiments of the invention;

FIGS. 15, 16 and 17 show possible operating diagrams for the bar solenoid valves according to the embodiment shown in FIG. 14;

FIG. 18 is a top plan view of a constructional variant of one of the cleaning fluid dispensing bars of the apparatus;

FIGS. 19, 20, 21, 22, 23 and 24 show corresponding details of the bar according to FIG. 18 in a side view and views along the cross-sectional lines X-X, XI-XI, XII-XII, XIII-XIII, XIV-XIV, respectively; and

FIG. 25 shows other details of the spraying bar according to FIGS. 18-24, viewed frontally and partly from the side of the nozzles.

### DETAILED DESCRIPTION OF EXEMPLARY EMBODIMENTS

Reference now will be made in detail to exemplary embodiments of the invention, one or more examples of which being illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

It is to be understood that the ranges and limits mentioned herein include all sub-ranges located within the prescribed limits, inclusive of the limits themselves unless otherwise stated. For instance, a range from 10 to 200 also includes all possible sub-ranges, examples of which are from 10 to 15, 170 to 190, 153 to 162, 145.3 to 149.6, and 187 to 200. Further, a limit of up to 7 also includes a limit of up to 5, up to 3, and up to 4.5, as well as all sub-ranges within the limit, such as from about 0 to 5, which includes 0 and includes 5 and from 5.2 to 7, which includes 5.2 and includes 7.

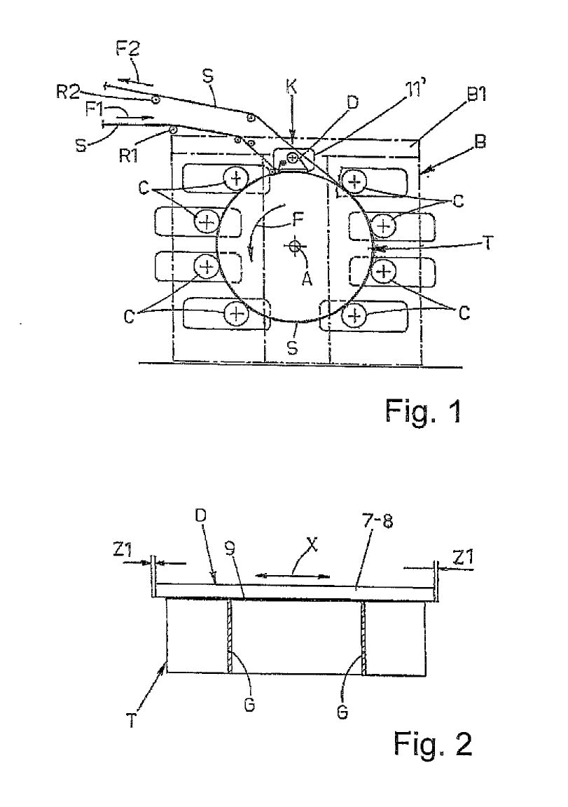

FIG. 1 illustrates schematically the industrial field and method of use of the apparatus according to the invention. This drawing schematically illustrates a classical printing machine of flexographic type, which includes a central cylinder or drum T whose axis A is borne rotatably by the shoulders (see below) of a base B and which is made by suitable means to rotate in the direction of arrow F. Input roller R1 and output roller R2 guide and relay the web-form substrate S to be printed over the outer circumferential surface of the said drum T, which drives and advances the web-form substrate S in the direction of the input arrow F1 and output arrow F2. While the web-form substrate S is being relayed over the drum T, the outer surface of the substrate S is printed by a succession of printing cylinders C, which also are supported rotatably through their ends by means connected to the shoulders of the base B and which are rotated by suitable means in phase and in revolving manner over the said substrate S.

By way of introduction, the term “length” is the circumferential dimension measured in the direction of rotation around the circumference of drum T in FIG. 1, the term “width” is the transverse dimension measured in the direction of the rotational axis of drum T in FIG. 1, and the terms “upstream” and “downstream” are considered in relation to the direction of rotation of said drum T.

For the periodic cleaning of the drum T from the dirt induced by the transit of the substrate S and by the action of the printing rollers C on the substrate S, a cleaning device D is used and provided with cloth, presser and dispenser of cleaning fluid. The cleaning device D desirably is configured with the capability of operating substantially over the entire transverse extension of the portion of the drum T that remains uncovered by the substrate S to be printed. The width of the drum T in a typical flexographic printing machine measures in the range of 1.2 meters to 2.2 meters. As shown in FIG. 1, that uncovered portion of the drum T is located between the input and the output zones of the substrate S. When the cleaning device D is in the working position, the cleaning device D is mounted on means which guide the cleaning device D and move the cleaning device D with rectilinear, alternating movements parallel to the axis of rotation of the drum T. Examples of apparatus suitable to this manner of moving the cleaning device D with alternating rectilinear movements parallel to the axis of rotation of the drum T are provided below. Another type of suitable apparatus for effecting such movements is described in the Italian patent application no. BO 2010 A-56 of Feb. 2, 2010 cited above in the background.

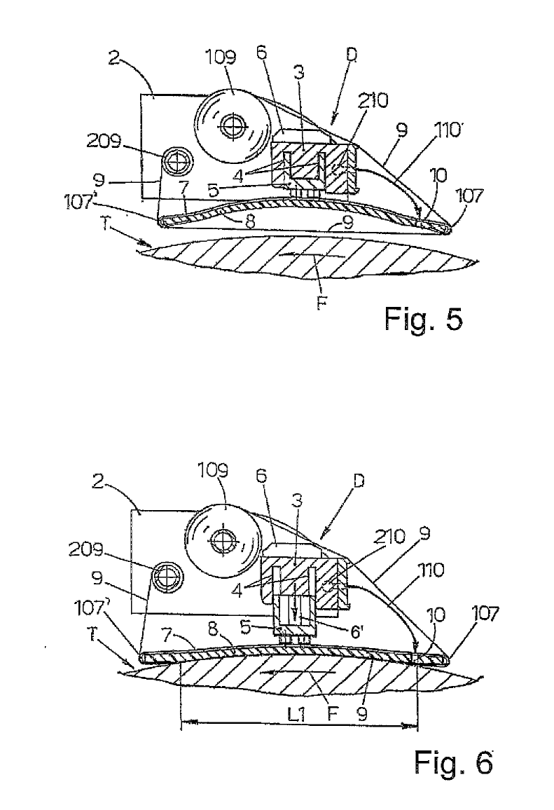

As illustrated in the example in FIGS. 5-8, the cleaning device D comprises a pair of parallel shoulders 2 fixed to the ends of at least one cross-piece 3 having a width correlated with the width of the outer circumferential surface of the drum T and disposed parallel to the axis of this drum T. The cross-piece 3 defines a recess 4 having a U-shaped profile that opens towards the outer circumferential surface of the drum T. A beam 5 with a corresponding U-shaped profile slides in the recess 4 of the cross-piece 3 in what is the radial direction with respect to the rotational axis A of the drum T. As schematically shown in FIG. 6, at least one pair of cylinder-and-piston assemblies 6, 6′ under fluid pressure is symmetrically arranged between the relevant parts 4 and 5. The cylinder-and-piston assemblies 6, 6′ can be activated to raise the beam 5 to the rest position shown in FIG. 5 or to lower the beam 5 into the working position as shown in FIGS. 6, 7 and 8.

In the exemplary embodiment as shown in FIG. 5, the intermediate part of a plate 7, which is rectangular on plan and as wide as said beam 5, is fixed to the beam 5 of the device D. The plate 7 is defined by a curved lateral profile and is oriented with the concave part facing towards the drum T and having a radius of curvature suitably smaller than that of the drum T itself. The plate 7 desirably is formed for example from a sheet of spring steel, of suitable thickness and/or of composite material, so as to have suitable characteristics of flexibility in the direction of length L1 shown in FIG. 6.

Plate 7 has each of its ends 107, 107′ slightly curved upwards away from the drum T with a rounded profile forming a channel into which channel is inserted and supported one of the opposite ends of a sheet 8 of elastomeric material, of suitable characteristics of thickness and hardness, which in the example shown in FIG. 5 is uniformly fixed to the lower face of plate 7, for example by vulcanization. The presser is formed by the combination of the plate 7 and the elastomeric sheet 8 fixed thereto. The length L1 of the presser 7, 8 desirably can be comprised for example in the range of approximately 10-100 cm and desirably has a length in the range of at least 10-35 cm, and a length L1 in the range of at least 20-25 cm is also desirable. Thus, the length L1 of the presser 7, 8 measured in relation to the circumferential direction of the rotation of the drum T is at least three times greater than the length of a presser of a traditional cleaning system.

Parallel to the cross-piece 3, the shoulders 2 of the cleaning device D rotatably support the ends of the reels 109 and 209 for respectively feeding unsoiled segments of the cleaning cloth 9 and collecting the soiled segments of the cleaning cloth 9, which with the correct longitudinal tension runs below the long presser 7, 8 just described. Good results were obtained with the use of a thick cloth, on the order of 0.3 to 0 8 mm for example, and having a sparse mesh structure, such as honeycomb, which allows the cleaning fluid to pass easily through the cleaning cloth 9 and enables the cleaning cloth 9 to trap a large quantity of ink and dirt to move and to spread this ink and dirt effectively together in the transverse direction on the outer surface of the drum T.

The apparatus of the cleaning device D also desirably includes apparatus that dispenses cleaning fluid and that includes means for delivering onto the front face of the presser 7, 8 and the cleaning cloth 9, particularly that upstream portion of the presser's face which is first affected by the direction of rotation F of the drum T, exact distributed quantities, equal or differentiated, of cleaning fluid. These means for delivering cleaning fluid comprise for example holes 10 in the front face of the presser 7, 8, which affect for example, both parts 7, 8 of the presser itself, to which the fluid is fed with any suitable transport means schematically indicated by 110, connected to a feed manifold 210, formed for example with any suitable known means in cross-piece 3. It remains understood that according to a constructional variant, not illustrated, the feed manifold 210 with the internal splitting circuits, can be connected to the upper part of plate 7 and can incorporate said transport means 110, all in intuitable manner and easily executed by persons skilled in the art, on the basis of known implementations.

The apparatus as shown in FIG. 5 operates as follows. When it is necessary to provide for the cleaning of the outer circumferential surface of the drum T, the cylinder-and-piston assemblies 6, 6′ are fed with incompressible fluid so as to be extended in order to thrust the presser 7, 8 towards the drum T (which remains in rotation at reduced speed) and for example in the direction of the arrow F. The presser 7, 8 touches the drum T first with its ends parallel and then flexed, and adapts itself to the lateral surface of the drum T also with its own intermediate part, so as to create distributed contact, with contact pressures suitably distributed, as illustrated in FIG. 6. At the correct stage, an exact quantity of cleaning fluid is fed to the holes 10, and through the cleaning cloth 9 this same cleaning fluid reaches the lateral surface of the drum T (see below).

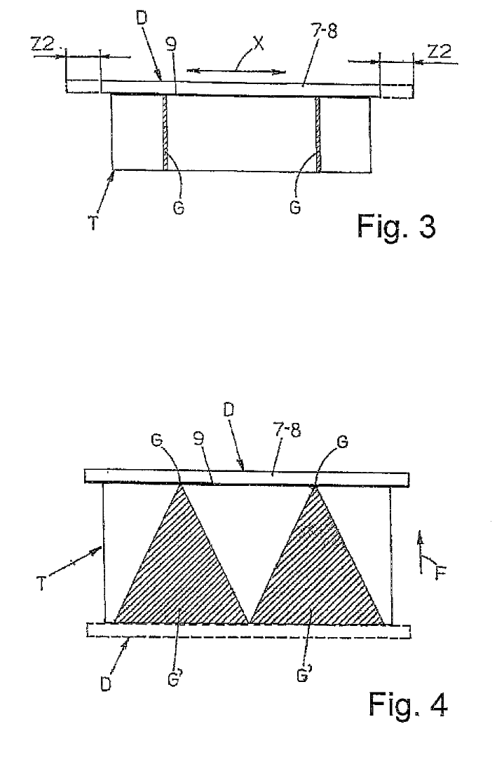

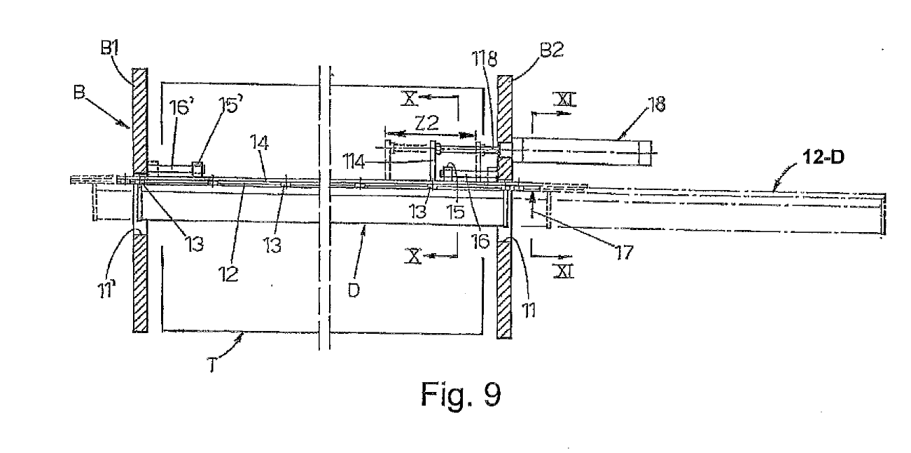

An oscillator is provided that animates the entire cleaning assembly D with the shoulders 2, and with the presser 7, 8 and the cleaning cloth 9 on board, with a transverse oscillatory movement X as shown in FIG. 2 or 3, with a rapid stroke Z1 of small amplitude (e.g., 5 to 10 cm), as in FIG. 2, or with a slower, long stroke Z2 (e.g., 11 to 50 cm), as for example in FIG. 3 or as described below with reference to FIG. 9. This transverse oscillation imparted by the oscillator ensures that the dirt of the format lines G indicated in FIGS. 2 and 3 and at the top of FIG. 4, in contact with the cleaning cloth 9 thrust by the presser 7, 8 and with cleaning fluid being delivered, is progressively widened and spread over the lateral surface of the drum T. In this manner of oscillation, before exiting from contact with the cleaning cloth 9 itself and the long presser 7, 8, the dirt of the format lines, with the little cleaning fluid delivered, is extended transversely in a fan shape as indicated by G′ in FIG. 4 and becomes of such a thin consistency and of such fluidity as to be able to be absorbed by the last stretch of cleaning cloth 9 which is active, so that the drum T comes out of the cleaning system under discussion substantially clean and dry.

If the dirt of the format lines was of particular thickness, some of it could come out of the cleaning system, but it is always distributed, in a thin layer and with good fluidity, and can therefore easily be removed by the substrate S if this remains in contact with the drum T during the cleaning phase and/or can certainly be removed in a subsequent turn of the drum by the cleaning cloth 9 of the previous cycle and/or by the clean surface of a short new stretch of cleaning cloth 9 which is inserted at least under the first zone of the presser 7, 8 during a rapid activation of the reels 109, 209 and a rapid raising and lowering of this same presser component 7, 8, which can remain in oscillatory movement X as in FIG. 2 or 3, or which can remain in static and centered position, as in FIG. 4. The considerable length L1 of the presser 7, 8 and the cleaning cloth 9 assembly, and the pressures which this assembly exerts on the drum T, ensure that a first front and median zone of the cleaning cloth 9 rapidly widens the dirt and that the last median-rear zone of the same cleaning cloth 9 is able to carry out a stage of finishing and drying the surface of the drum T before the drum T loses contact with the long presser 7, 8 and the cleaning cloth 9 underneath.

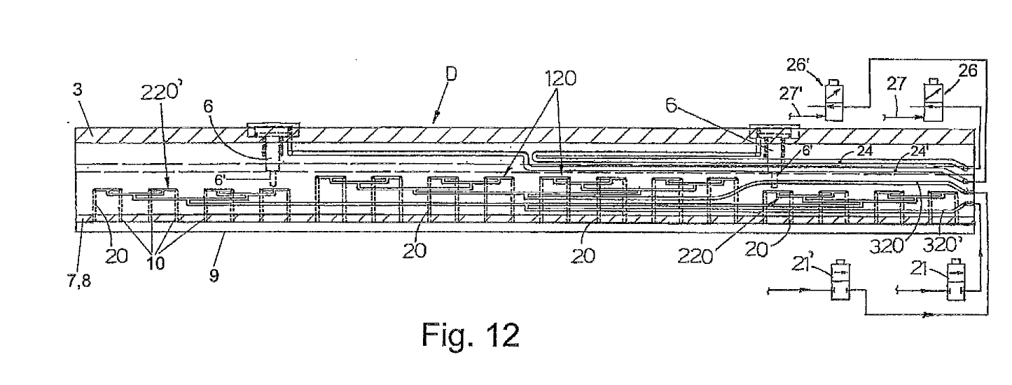

Means desirably are provided for ensuring that said feeding of the cleaning fluid occurs in such a way that the cleaning fluid itself is distributed transversely onto the cleaning cloth 9 in the quantity which is strictly necessary and never excessive, even as a result of the alternating movement of transverse oscillation of the presser-and-cloth assembly 7, 8, 9 of the cleaning device D and its relative movement over the surface of the drum T to be cleaned, for example with a quantitatively differentiated distribution of said cleaning fluid, which distribution decreases from the center towards the outside edges of the presser-and-cloth assembly 7, 8, 9 of the cleaning device D. For this purpose a distribution device in the form of a feed manifold 210 and associated fluid transport apparatus 110 may be used, but without limiting effect, of the type schematically depicted in FIG. 12 and which now will be described.

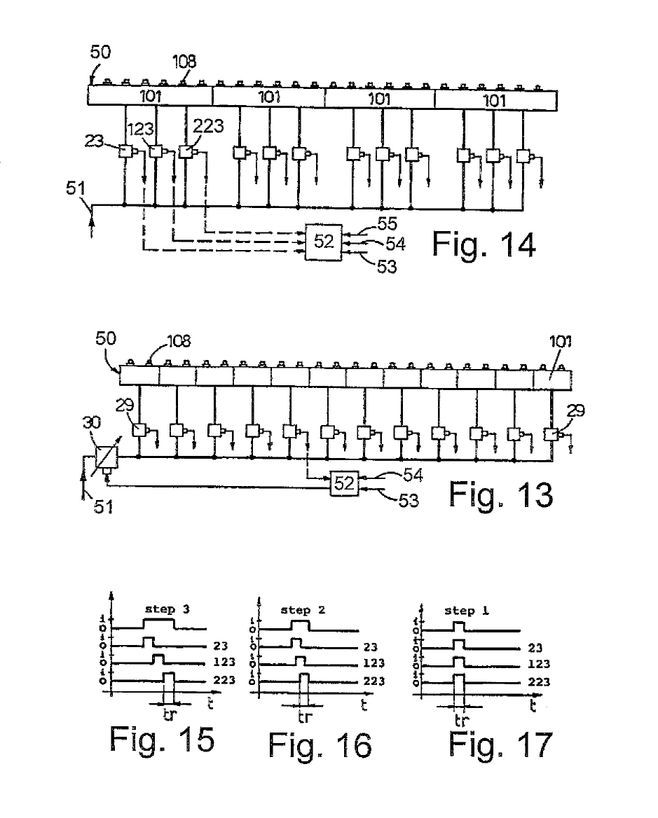

One implementation of suitable cleaning fluid transport means schematically indicated by 110 connected to a feed manifold 210 in FIGS. 5-8 is schematically illustrated in FIG. 12. As schematically shown in FIG. 12, in the lower portion of the cross-piece 3, and located upstream of the presser 7, 8, there is provided side by side a plurality of conduits 20, which lead to the holes 10 through the presser 7, 8 and are fed from three distribution circuits 120 and 220, 220′, the first of which is at a central location, while others are lateral and symmetrical in location and are connected to two separate supply channels 320, 320′ disposed at the same end of the cross-piece 3 from which are connected by means of respective external valves 21, 21′ to sources of a supply of cleaning fluid and/or lubrication, including solvent and/or water. The delivery channels 120, 220, 220′, 320, 320′ can be obtained on the cross-piece 3 with a milling operation in the same way of the ducts 24, 24′ that supply to the cylinder-and-piston assemblies 6, 6′ incompressible fluid from respective pressurized sources 27, 27′ via respective metering valves 26, 26′, which can be selectively operated to connect the cylinder-and-piston assemblies 6, 6′ to a low pressure, return reservoir of incompressible fluid. With the embodiment described with reference to FIG. 12, it is possible to extend the cleaning fluid and/or lubrication to one central area and/or areas of the lateral part of the cleaning cloth 9 for contacting the steel drum T through the presser 7, 8, and bringing to these areas of the cloth 9 different cleaning fluids in quality and/or quantity. Each of these valves 21, 21′ (and valves 26, 26′ for that matter) desirably can be operated by a programmable controller 52 (FIGS. 13, 14 and 18, but not shown in FIG. 12), and metering valves (FIGS. 13, 14 and 18, but not shown in FIG. 12) desirably can be disposed between each of these valves 21, 21′ and the delivery channels 120, 220, 220′, 320, 320′ and operated by the programmable controller to vary the quantity and timing of the delivery of the cleaning fluid from the holes 10 to the cleaning cloth 9.

As schematically shown in FIGS. 13, 14 and 18 for example, the feed manifold 210 desirably comprises at least one spraying bar 50, which desirably is provided with a plurality of nozzles 108. The spraying bar 50 desirably is carried by the cross-piece 3 and situated transversely behind the presser 7, 8 of the cleaning device D, and the nozzles 108 of the spraying bar 50 desirably are directed through the holes 10 in the presser 7, 8, so as to inject predetermined quantities of solvent which can be varied depending on the feeding speed of the cleaning cloth 9, as well as other variables. The cleaning fluid desirably is supplied onto the cleaning cloth 9 by the spraying bar 50, by means of the said nozzles 108 and holes 10.

It is understood that the composition of the apparatus for supplying the cleaning fluid onto the cleaning cloth 9, as mentioned with reference to FIGS. 1 and 5-8, is purely exemplary and that the improvements in question are applicable to any unit having at least one spraying bar 50. The feed manifold 210 is able to regulate the transverse supply of the cleaning fluid supplied by the spraying bar 50, depending on the width of the cleaning cloth 9 inserted in the cleaning device D, in order to avoid unnecessary supply of the cleaning fluid along the flanks of the cleaning cloth 9 and therefore facilitate the action of the cleaning device D according to FIGS. 1 and 5-8 and improve the distribution of the cleaning fluid on the said cleaning cloth 9, also depending on the amount of dirt spread over the drum T to be cleaned.

As schematically shown in FIG. 14 for example, the spraying bar 50 for supplying the cleaning fluid desirably is divided into several sections 101 arranged adjacent to each other, and each section desirably comprises several nozzles 108 for supplying the cleaning fluid and is supplied by at least one line 51. As schematically shown in FIG. 13 for example, several respective intercept solenoid valves 29 of the ON-OFF type control the flow of the cleaning fluid supplied from a metering valve 30, for example of the modulated or other suitable type, which is managed by a processing unit 52 having an input 53 which sends a signal proportional to the width of the cleaning cloth 9 inserted in each case in the cleaning device D and having a further input 54 for the signal proportional to the feeding speed of the said cleaning cloth 9. Depending on the width of the cleaning cloth 9 used, the apparatus is able to regulate automatically the number of active nozzles 108 of the spraying bar 50, so as to supply cleaning fluid essentially over the width of the cleaning cloth 9, deactivating the sections 101 with the nozzles 108 which would supply cleaning fluid along the flanks of the said cleaning cloth 9. The variations in the quantity of cleaning fluid supplied by the active nozzles 108 of the spraying bar 50 may be achieved in a uniformly distributed manner by means of the metering valve 30.

As schematically shown in FIG. 14 for example, the line 51 supplying the cleaning fluid to the various sections 101 of the spraying bar 50 is intercepted by several respective ON-OFF solenoid valves, which are for example at least two in number as indicated by 123, 223 and are controlled by the said processing unit 52, which has an input 53 for modifying the quantity of cleaning fluid supplied by each bar section 101 depending on the through-speed of the strip of the cleaning cloth 9 and which has an input 54 for activating the said sections 101 which act on the width of the cleaning cloth 9 which is inserted in each case in the cleaning device D, with deactivation of the sections 101 of the spraying bar 50 situated along the flanks of the said cleaning cloth 9, so as to avoid unnecessary supplying of cleaning fluid along the flanks of the said cleaning cloth 9 so as to avoid applying cleaning fluid on portions of the drum T that will not be reached by the cleaning cloth 9 and thus avoid waste of the cleaning fluid. By then operating one and/or the other of the said solenoid valves 123, 223 associated with each section 101 of the spraying bar 50 of the cleaning device D, it is possible to vary the quantity of cleaning fluid supplied by the said active section 101 of the spraying bar 50.

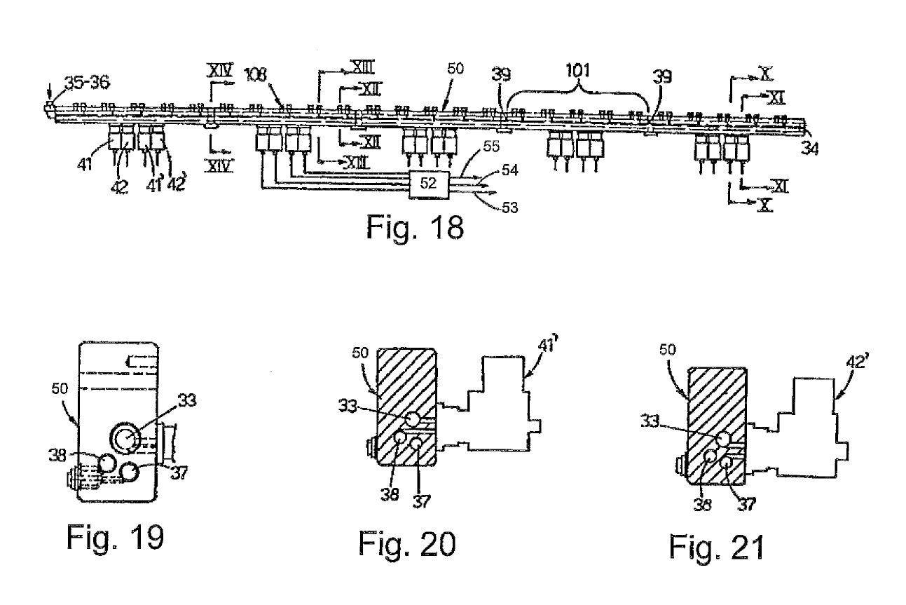

As schematically shown in FIG. 14 for example, the processing unit 52 has a further semi-automatically or automatically controlled input 55 which, depending on the distribution of the dirt on the drum T, allows regulation of the quantity of cleaning fluid which is supplied transversely onto the cleaning cloth 9 by the adjacent sections 101 of the spraying bar 50 of the cleaning device D, so that more cleaning fluid (or cleaning fluid with a higher concentration of solvent) reaches the dirtier zones of the drum T than the cleaning fluid which reaches the cleaner zones. As schematically shown in FIGS. 14 and 18 for example, the input command 55 may for example be obtained with a sensor which reads from the ink tank of the machine the quantity of ink used by the said machine and/or by reading with optoelectronic sensors or with telecameras the quantity and the concentration of ink which is present in the matrix of the printing cylinder C and which will be transferred to the substrate S during printing.

According to a further possibility, the signal to the said input 55 may be provided semi-automatically by an operator who, after a washing cycle, determines which zones of the drum T are dirtier and require a greater quantity of cleaning fluid (or cleaning fluid with a higher concentration of solvent) than other zones and transmits the signal to the said input 55 in order to activate the varied supplying of cleaning fluid by the active sections 101 of the spraying bar 50 of the cleaning device D, which supply the solvent onto the cleaning cloth 9.

As schematically shown in FIG. 13 for example, upstream of the supply line 51, a valve means 30 of the static or dynamic type may be envisaged, said means consisting, for example, of a throttle valve or a modulated solenoid valve which if desired is managed by the processing unit 52 and which, depending on the rated characteristics of the printing machine, allows safe control of the overall quantity of cleaning fluid supplied to the feed manifold 210 and released by the latter to the cleaning cloth 9. The processing unit 52 and/or the said limiting valve means 30 shall have the task of controlling safe operation of the various solenoid valves 123, 223, and can for example be programmed so as to ensure that, when the supply of the solvent in certain zones of the cleaning cloth 9 is increased, in other zones of the cleaning cloth 9 the supply of the said solvent is automatically decreased, so as to keep constant the total quantity solvent sprayed per second by the spraying bar 50, so that this total quantity corresponds always to the maximum value which can be supplied.

As schematically shown in FIG. 14 for example, which allows the use of solenoid valves with the same throughput and allows a wider selection of the quantity of cleaning fluid supplied by the spraying bar 50, each section 101 of the said spraying bar 50 is supplied by the line 51, by means of a respective set of three solenoid valves 23, 123, 223 managed by the processing unit 52 which has the usual input 53 for the signal relating to the width of the cleaning cloth 9, an input 54 for the signal relating to the feeding speed of the said cleaning cloth 9 and an input 55 which sends signals relating to the distribution of the dirt on the drum T to be cleaned and emitted by automatic or semi-automatic sensing systems mentioned above, so as to activate the varied supplying of cleaning fluid by the various sections 101 of the spraying bar 50 of the apparatus which supply said cleaning fluid onto the cleaning cloth 9. The overall or selective variations in the quantities of the cleaning fluid supplied by the sections 101 of the spraying bar 50 may in this case be managed by the processing unit 52, which operates each set of three solenoid valves 23, 123, 223 with constant or different opening times tr and with a step 1, step 2 or step 3 as schematically shown for example in FIGS. 15, 16 and 17 so that more or less cleaning fluid reaches transversely certain zones of the cleaning cloth 9 depending on the concentration of the dirt on the surface of the drum T to be cleaned.

It is understood that the circuits shown in FIGS. 13 and 14 are schematic and purely exemplary and that they may be improved with all those solutions which may occur to persons skilled in the art in order to ensure that the cleaning fluid is distributed with the necessary pressure and flow rate to the various sections 101 of the supplying bar 50 and so as to ensure that the system operates under safe conditions, avoiding an excessive supply of the solvent, which could create problems.

With reference to FIGS. 18 to 25, a spraying bar 50, which can be easily produced on an industrial scale and is able to satisfy the above-mentioned requirements of safe and varied supplying of the nozzles 108, is now described. From FIGS. 18 and 19 and 14 it can be seen that the spraying bar 50 comprises at least one main longitudinal channel 33 which desirably is closed at one end with a plug 34 and which at the other end is connected to the cleaning fluid supply line 51, via a union 35 and with the arrangement, in between, of a flow rate regulating valve means 36—consisting for example of a throttle valve—the characteristics of which may vary depending on the maximum width of the cleaning cloth 9 which can be inserted in the cleaning device D and/or any other parameters. These valve means 36 have the function of limiting the maximum quantity of cleaning fluid which the bar 50 can supply onto the cleaning cloth 9. These same valve means 36 may also be envisaged in the embodiment of the spraying bar 50 considered above with reference to FIG. 14.

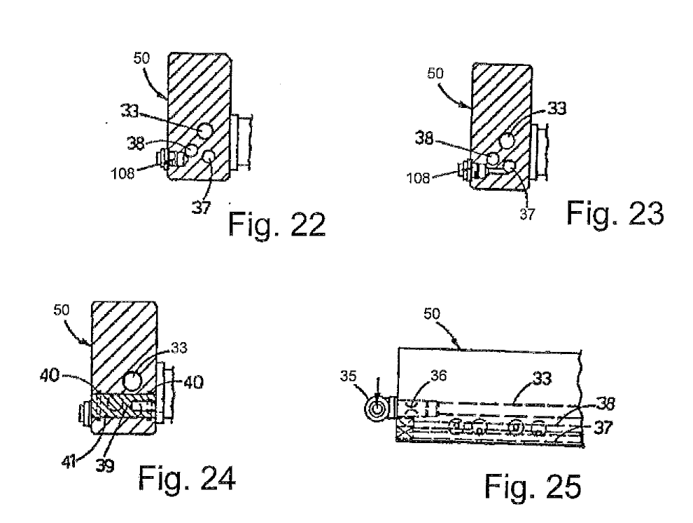

Two secondary channels 37 and 38, for example with the same cross-section, desirably are provided parallel to the supply channel 33 at a different distance from the said main channel 33. These secondary channels 37, 38 desirably are closed at the ends with sealing plugs and divided into sections of equal length, by means of pins 39 (FIG. 25) inserted with sealing means 40 into transverse holes 41 formed in the bar. The pins desirably have a diameter such as to intercept both the said secondary channels 37, 38, these pins being fixed in situ with any suitable means. With these pins 39, the secondary channels 37, 38 are divided, for example, into five portions or sections and each section has a plurality of nozzles 108, for example ten nozzles 108, which are alternately connected to each of the said sections of secondary channels 37, 38, as shown in the detail of FIGS. 22 and 23. Each section of said secondary channels 37, 38 may be connected to the main supply channel 33 by means of pairs of solenoid valves for example two pairs of solenoid valves 41, 41′ and 42, 42′, which have the same flow rate characteristics and are of the ON-OFF type, as shown in the details of FIGS. 20 and 21. It is clear how, for each section of the secondary channels 37, 38, with the respective nozzles 108, depending on supplying of the said solenoid valves 41, 41′ and 42, 42′, the cleaning fluid may be supplied in a variable quantity by the nozzles 108 served by the secondary channel section 37 and/or by the nozzles 108 served by the secondary channel section 38.

If necessary, the supply to each bar section 101 with its ten nozzles may even be stopped when it is required to supply the cleaning fluid onto cleaning cloth 9 with a width smaller than the maximum width which can be inserted in the cleaning device D. In this case, also, as in the case of FIG. 14, the various solenoid valves will be managed by a processing unit 52, which has the usual inputs 53, 54 and 55 for the operational adaptation depending on the width of the cleaning cloth 9, depending on the feeding speed of the said cleaning cloth 9 and depending on the distribution of the dirt on the printing machine drum T to be cleaned. The processing unit 52 according to FIG. 18, as well as the processing unit 52 according to FIGS. 13 and 14 and/or the said flow rate limiting valve means 36 desirably can be controlled so that when the supply of cleaning fluid to certain zones of the cleaning cloth 9 is increased, the supply of the said cleaning fluid in other zones of the cleaning cloth 9 is automatically decreased, so as to keep constant the total quantity of solvent sprayed per second by the spraying bar 50, so that the total quantity always corresponds to the maximum amount which can be supplied.

Owing to optimization of the varied supply of the solvent by the nozzles 108 of the various adjacent sections 101 of the spraying bar 50, it is possible to obtain uniform washing over the entire width of the cleaning cloth 9, which condition could not be ensured by a homogeneous and uniformly distributed supply, since the dirt is never uniformly distributed over the width of the drum T. With optimization of the varied supply of the cleaning fluid in the transverse direction of the cleaning cloth 9, the cleaning times for the zones of the drum T acted on by the different sections 101 of the spraying bar 50 of the cleaning device D will tend to be the same, so that the washing times for the printing machine will be shorter than those of the prior art and it will be possible to reduce the overall quantity of solvent used for each washing cycle.

The cleaning device D as described may be set to perform conventional washing cycles or perform so-called “microwashing” which may be managed by the processing unit 52 via the signal to the input 55 which detects the gradual accumulation of dirt on the different zones of the drum T. With activation of the sections 101 of the spraying bar 50, which are aligned with the zones where there is a gradual accumulation of the dirt on the drum T, while the printing machine remains in the normal operating condition, it will be possible to supply to the said dirty zones very small quantities of solvent which will soften the said dirt and favor gradual removal thereof during contact with the cleaning cloth 9, without adversely affecting the legibility and the quality of the print produced by the machine. Microwashing may otherwise be performed by supplying to the said dirty zones of the drum T large quantities of solvent in a short amount of time, so as to dissolve the said dirt and favor rapid removal during contact with the cleaning cloth 9, the soiled sections of which involved in this cycle are then destined for disposal. It is clear how these microwashing operations may increase the time intervals between the main washing cycles and how they may simplify the times and costs of these same main cycles.

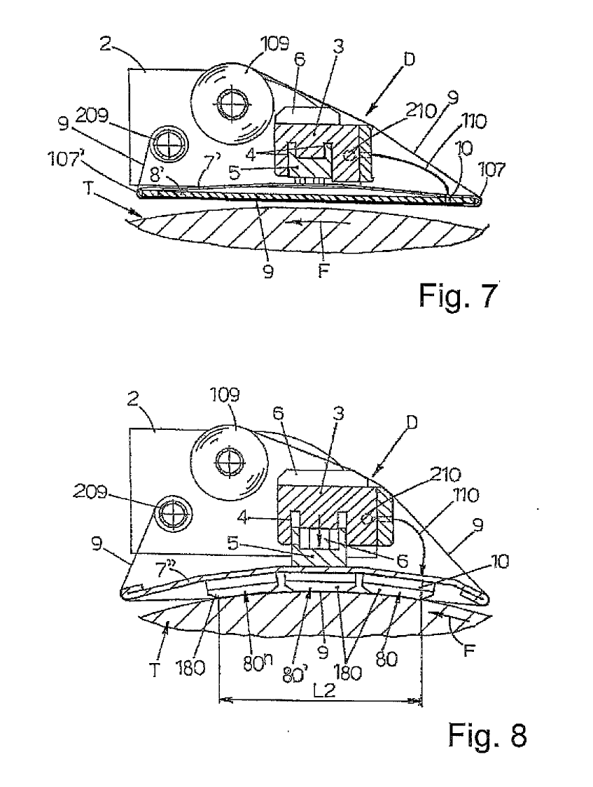

FIG. 7 illustrates a constructional variant of the apparatus with long presser 7′, 8′ and cleaning cloth 9, which like the variant described above has the advantage of adapting itself automatically to drums T of different diameter. According to this variant the upper plate 7′ of the presser is similar to the upper plate 7 referred to above but can have limited flexibility and is predisposed for supporting the elastomeric sheet 8′ with a stretched arrangement, like a bowstring. The elastomeric sheet 8′ may in this case be suitably reinforced with a flexible internal armature (not visible in the view shown in FIG. 7). The cleaning cloth 9 is routed under this presser 7′, 8′ exactly as in the previous case depicted in FIGS. 5 and 6 for example. When such a presser 7′, 8′ is thrust against the drum T, the elastomeric sheet 8′ adapts intimately to the surface of the drum T, thrusting into contact with the drum T a large stretch of cleaning cloth 9, which will be moistened on the front where the drum T makes contact, by means similar to the holes 10 connected via transport means schematically indicated by 110 connected to a feed manifold 210 referred to above and with the same procedure as just described.

The variant in FIG. 8 teaches that the plate 7″ can be much more solid than the one in the previous exemplary embodiments and thus substantially rigid. The plate 7″ desirably can have a radius of curvature correlated to that of the drum T. The plate 7″ desirably can carry, fixed to its lower face, with an arrangement parallel to each other and to the outer circumferential surface of the drum T, a plurality of beam-shaped pressers 80, 80′, 80″ of conventional type, with a lower part 180 of elastomeric material. The length L2 of such a composite presser 7″, 80, 80′, 80″ may be of the order of at least 10 cm or may be greater as described above to 100 cm, in which case under the plate 7″ there may be fixed more than three beam-shaped pressers. The cleaning fluid will be fed to the front face of the upstream beam-shaped presser 80 through a cleaning fluid feeding circuit 10, 110, 210 similar to the one in the previous exemplary embodiments described above. At least the first beam-shaped presser 80 shall in this case desirably be characterized by having a thrust surface of its elastomeric part 180, of embossed type like for example the one described in United States Patent Application Publication No. 2006-0137553, which is hereby incorporated herein in its entirety for all purposes. While the downstream beam-shaped presser 80″ and indeed each of the other beam-shaped pressers 80′, 80″, 80′″, etc. may have a thrust surface which is smooth or substantially so.

The upstream beam-shaped presser 80 with an embossed surface carries the cleaning fluid to the cleaning cloth 9 and to the dirt and exerts an intense mechanical action on said dirt, at the same time exerting a firm grip on the cleaning cloth 9, which is thus prevented from sliding transversely relative to each beam-shaped presser 80, 80′, 80″ when the latter oscillates transversely as described by X and with reference to FIGS. 2 and 3. The beam-shaped pressers with smooth surface 80′, 80″ with their cleaning cloth 9 underneath complete the action of the upstream beam-shaped presser 80, with a finishing and drying action on the thin film of wet and smeared dirt. It remains understood that the elastomeric sheet 8, 8′ of the exemplary embodiments shown in FIGS. 5 and 7 also may advantageously be equipped with at least one lower upstream embossed segment, to perform the same functions as the exemplary embodiment with the composite presser as described above with reference to FIG. 8.

The exemplary embodiment just described of oscillation X of the cleaning device D with a long stroke Z2, as illustrated in the example shown in FIG. 3, offers the advantage of involving a larger quantity in a transverse direction of the portion of cleaning cloth 9 touching the drum T, and of being able to perform the said oscillation with a not excessive speed, with fewer problems of a mechanical type and greater reliability of operation over time. The scope of the invention also covers the implementation according to which the width of the cleaning device D with the cleaning cloth 9 can be greater than that illustrated in the drawings and substantially so or at least equal to the sum of the width of the drum T and of the alternating stroke which the said device D must execute in the phase of cleaning the drum T, all in such a way that the cleaning cloth 9 always touches the drum T over its entire transverse extension, with the advantages that derive from this condition. Thus, the segment of the cleaning cloth 9 stretched over the presser 7, 8 for example is at least equal to the sum of the width of the drum T and the alternating stroke (to and fro) which the presser 7, 8 performs cyclically during the cleaning phase so that the cleaning cloth 9 always touches the drum T over its entire transverse extension during each cycle of alternating strokes when the cleaning device D is operating in the cleaning phase.

To allow the cleaning device D to oscillate with long strokes and/or for other necessities referred to below, which may be independent of said oscillating stroke of the device D, the possibility is provided of preparing on the shoulders B1, B2 of the base B (FIGS. 1 and 9), some openings, windows, slots or recesses 11, 11′, of appropriate open area, through which said cleaning device D is configured to pass so that the cleaning device D can move freely with sections of its opposed ends, as indicated in FIG. 9 by a dashed line.

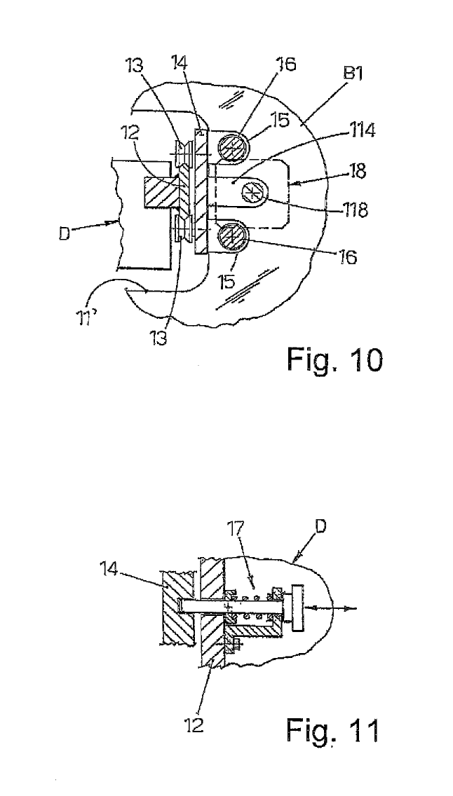

In the exemplary embodiment shown in FIGS. 9 and 10, the oscillator can be implemented by providing the cleaning device D with a primary slide 14, which by means of end bushes 15, 15′ slides on pairs of rods 16, 16′ fixed perpendicularly onto internal faces of the shoulders B1, B2 of the flexographic machine. The oscillator can further include a parallel secondary slide 12 which, with its profiled edges, can run, with a sliding drawer movement, between pairs of rollers 13 laterally fixed to the primary slide 14. By means of at least one safety latch 17 (FIGS. 9, 11), located and carried for example on an end extension of the secondary slide 12, this secondary slide 12 can be made integral with the primary slide 14 so as to be able to be carried by the primary slide 14, together with cleaning device D, on the necessary oscillation stroke Z2, for example under the control of a double-acting cylinder-and-piston assembly 18 under fluid pressure, fixed with its body on shoulder B2, which with rod 118 passes through a hole in this shoulder B2 and which with the same rod 118 is integral with a bracket 114 on the primary slide 14. Thus, the double-acting cylinder-and-piston assembly 18 under fluid pressure provides an actuator of alternating rectilinear motion that is constrained to one of the said shoulders (B2) of the printing machine.

For the periodic replacement of the reels 109, 209 of cleaning cloth 9 on the cleaning device D, it is possible to neutralize the latch 17 and remove slide 12 with said cleaning device D from the primary slide 14 and later refit it, as illustrated in FIG. 9 with dashed and dotted lines, passing the cleaning device D through a window 11 in one of the shoulders B2 of the flexographic machine. From FIG. 1 it appears evident that, since it is possible to effect the said operation of changing the cleaning cloth 9 by moving the cleaning device D through one of the window openings 11′, 11 in one of the shoulders B1, B2, said cleaning device D does not interfere during printing with substrate S, which for this reason does not need to be cut before being able to replace the soiled cleaning cloth 9 with a fresh supply of unsoiled cleaning cloth 9, as is required by contrast in the prior art.

Desirably, the controller 52 is programmed and connected to the oscillator to control operation of the oscillator as well as programmed and connected to the respective metering valves 26, 26′to control operation of the cylinder-and-piston assemblies 6, 6′ that move the beam 5 toward and away from the drum T to lower the beam 5 into the working position shown in FIG. 6 or to raise the beam 5 to the rest position shown in FIG. 5. The controller 52 is further desirably programmed and connected to rapidly activate the reels 109, 209 to place the clean surface of a short new stretch of cleaning cloth 9 at least under the first zone of the presser (e.g., 7, 8), and this rapid activation of the reels 109, 209 can occur while the drum T is rotating. Moreover, the controller 52 is further desirably programmed and connected to operate the oscillator, the reels 109, 209 and the cylinder-and-piston assemblies 6, 6′ during a rapid raising and lowering of the presser component (e.g., 7, 8), which can remain in oscillatory movement X as in FIG. 2 or 3, or which can remain in static and centered position, as in FIG. 4.

It remains understood that the description has referred to some presently preferred exemplary embodiments of the invention, omitting graphic illustration of some alternative constructional details of the circuit for feeding the cleaning fluid(s) and of any compensation means for the longitudinal tension of the cloth, because these are easily realizable by persons skilled in the art. It therefore remains understood that numerous constructional variants and modifications can be made to the invention, all moreover without abandoning the informing principle of the invention, as described and illustrated and as claimed below.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. Apparatus particularly suitable for the rapid cleaning of the rotating surface of the so-called central drum of flexographic printing machines around which drum the substrate to be printed is carried except at the uncovered portion of the drum located between the input and the output zones of the substrate to be printed, the flexographic printing machine having a base that carries the drum rotatably about the axis of rotation of the drum and defines a pair of shoulders spaced apart from each other in the direction of the axis of rotation of the drum, one such shoulder disposed at each end of the drum and located at the uncovered portion of the drum between the, input and the output zones of the substrate to be printed, the cleaning device apparatus comprising:
at least one cross-piece disposed parallel to the axis of the drum and slideably carried by and extending between the spaced apart shoulders of the flexographic printing machine;
a presser, a cleaning cloth and a dispenser of cleaning fluid carried by the cross-piece, each of the presser, cleaning cloth and dispenser of cleaning fluid being of a width at least as wide as the width of the drum;
an oscillator configured to impart to each of the presser and the cleaning cloth during a cleaning phase of operation, oscillating movement of alternating strokes directed parallel to the rotational axis of the drum; and
wherein at least one of the shoulders of the printing machine defines a window and the cleaning apparatus is configured to pass through this window in a movement directed parallel to the axis of rotation of the drum to permit replacement of the cleaning cloth without having to cut the substrate.

2. Apparatus according to claim 1, wherein the oscillator includes an actuator of alternating rectilinear motion which is constrained to one of said shoulders of the printing machine.

3. Apparatus according to claim 1, further comprising:
at least one primary slide located parallel to the axis of the drum to be cleaned and supported with its opposed ends and with the interposition of guide and slide means by the same shoulders which rotatably support the drum; and
an actuator of alternating rectilinear motion which is constrained to one of said shoulders and which is connected to the at least one primary slide.

4. Apparatus according to claim 1, further comprising:
at least one primary slide located parallel to the axis of the drum and supported with its opposed ends and with the interposition of guide and slide means by the same shoulders which rotatably support the drum.

5. Apparatus according to claim 4, further comprising:
at least one secondary slide connected to the at least one cross-piece, the at least one secondary slide being configured for sliding drawer movement directed parallel to the axis of rotation of the drum.

6. Apparatus according to claim 5, further comprising:
a latch that is carried by the secondary slide and that can be selectively locked to or unlocked from the at least one primary slide, said at least one primary slide being connected to an actuator of alternating rectilinear motion which is constrained to one of the shoulders of the printing machine.

7. Apparatus according to claim 1, wherein the dispenser of cleaning fluid is configured and disposed to deliver cleaning fluid through the upstream end of the presser.

8. Apparatus according to claim 1, wherein the length of the presser measured in relation to the circumferential direction of the rotation of the drum is at least three times greater than the length of a presser of a traditional cleaning system.

9. Apparatus according to claim 1, wherein the width of each of the presser and the segment of the cleaning cloth stretched over the presser is at least equal to the sum of the width of the drum and the alternating stroke which the presser performs in the cleaning phase so that the cleaning cloth always touches the drum over its entire transverse extension during the cleaning phase.

10. Apparatus according to claim 1, wherein each of the presser and the segment of the cleaning cloth stretched over the presser has a length comprised within the range of about 10-100 cm and the width of each of the presser and the segment of the cleaning cloth stretched over the presser is at least equal the sum of the width of the drum and the alternating stroke which the presser performs in the cleaning phase so that the cleaning cloth always touches the drum over its entire transverse extension during the cleaning phase.

11. Apparatus according to one to claim 1, wherein the presser defines a plurality of holes distributed over the width of the presser, to feed from the dispenser of cleaning fluid to the cleaning cloth and through the cleaning cloth to the drum that is to be cleaned, exact quantities of cleaning fluid in the necessary quantity and never in excess, the dispenser of cleaning fluid including:
a spraying bar having a plurality of sections, each section including a plurality of spraying nozzles; and
at least one valve connected to each section of the spraying bar.

12. Apparatus according to claim 11, further comprising a controller connected to the valves and programmed to control the valves to ensure that the feeding of cleaning fluid occurs in a way in which the cleaning fluid is distributed transversely onto the cleaning cloth with a quantitatively differentiated distribution of said cleaning fluid, decreasing from the center of the presser towards the outside ends of the presser.

13. Apparatus according to claim 1, further comprising a controller connected to the dispenser of cleaning fluid and configured to control the dispenser of cleaning fluid to dispense an exact quantity and distribution of cleaning fluid in relation to the length of the presser, the characteristics of the oscillatory movement of the presser and the speed of rotation of the drum so as to spread the dirt of a zone of the drum over the transverse extension of the drum in the form of a sufficiently thin film of sufficiently low solidity so that the thin film of dirt is removed from the zone of the drum within one revolution of the drum.

14. Apparatus according claim 1, further comprising a controller connected to the dispenser of cleaning fluid and configured to control the dispenser of cleaning fluid to dispense an exact quantity and distribution of cleaning fluid in relation to the length of the presser, the characteristics of the oscillatory movement of the presser and the speed of rotation of the drum so as to spread the dirt of each successive zone of the drum over the transverse extension of the drum in the form of a sufficiently thin film of sufficiently low solidity so that each successive dirty zone of the drum is dried and cleaned before exiting from the downstream end of the presser.

15. Apparatus according to claim 1, wherein the presser comprises:
at least one beam which is parallel to the axis of the drum;
at least one actuator connecting the beam to the cross-piece and configured to thrust the beam selectively away from or towards the drum;
a plate of rectangular shape, as wide as the beam, having a curved lateral profile with a concave lower face directed towards the drum with a radius of curvature smaller than that of the drum and formed with characteristics of flexibility in the direction of its length, the opposite ends of the plate being slightly curved upwards away from the drum; and
a sheet of elastomeric material uniformly fixed to the lower face of said plate with each respective end of the sheet supported in one of the slightly upwardly curved ends of the plate.

16. Apparatus according to claim 1, wherein the presser comprises:
at least one beam which is parallel to the axis of the drum;
at least one actuator connecting the beam to the cross-piece and configured to thrust the beam selectively away from or towards the drum;
a plate of rectangular shape, as wide as the beam, having a curved lateral profile with a concave face directed towards the drum with a radius of curvature smaller than that of the drum, the opposite ends of the plate being slightly curved upwards away from the drum; and
a sheet of elastomeric material fixed to the lower face of said plate with only each respective end of the sheet supported in one of the slightly upwardly curved ends of the plate, the elastomeric sheet being reinforced internally by a flexible member;
wherein the plate is formed with characteristics of limited flexibility in the direction of its length that predispose the plate for supporting the elastomeric sheet only by the ends thereof and with a stretched arrangement, like a bowstring in such a way that when the presser is thrust against the drum, the elastomeric sheet intimately adapts to the surface of the drum, thrusting a large length of cleaning cloth into contact with the drum with distributed pressure.

17. Apparatus according to claim 1, wherein the presser comprises:
a substantially rigid upper plate having a lower face directed towards the drum and defining a radius of curvature correlated with that of the drum;
and to the outer circumferential surface of said drum, each beam-shaped presser including a lower part of elastomeric material; and
wherein at least the lower part of the upstream presser includes a thrust surface of embossed type in order to exert an energetic action on the dirt.

18. Apparatus according to claim 17, wherein at least the lower part of the downstream presser includes a thrust surface which is substantially smooth in order to be able to carry out an effective action of finishing the cycle of cleaning the drum.

19. Apparatus according to claim 1, further comprising:
a rotatably supported feed reel for feeding unsoiled segments of the cleaning cloth and a rotatably supported collection reel for collecting soiled segments of the cleaning cloth, the feed reel and the collection reel being configured and disposed to carry the cleaning cloth under longitudinal tension beneath the presser; and
a controller connected to the feed reel and configured to control the feed reel to advance enough unsoiled cleaning cloth so that only unsoiled cleaning cloth initially touches the drum when the presser is next placed in a static position thrust against the rotating drum.

20. A method of changing the cleaning cloth of an apparatus for the rapid cleaning of the rotating surface of the central drum of flexographic printing machines around which drum the substrate to be printed is carried except at the uncovered portion of the drum located between the input and the output zones of the substrate to be printed, the flexographic printing machine having a base that carries the drum rotatably about the axis of rotation of the drum and defines a pair of shoulders spaced apart from each other in the direction of the axis of rotation of the drum, one such shoulder disposed at each end of the drum and located at the uncovered portion of the drum between the input and the output zones of the substrate to be printed, the rapid cleaning apparatus including a rotatably supported feed reel for feeding unsoiled segments of the cleaning cloth and a rotatably supported collection reel for collecting soiled segments of the cleaning cloth, the feed reel and the collection reel being carried by the pair of shoulders, the method comprising:
sliding the feed reel and the collection reel in the axial direction through a window in one of the spaced apart shoulders of the flexographic printing machine and away from between shoulders;
replacing the feed reel and the collection reel; and
sliding the feed reel and the collection reel in the axial direction through the window in one of the spaced apart shoulders of the flexographic printing machine to replace the feed reel and the collection reel between shoulders.
